(19) United States
(12) Patent Application Publication
(10) Pub. No.: US 2023/0135302 A1
(43) Pub. Date: May 4, 2023

(54) COMPRESSOR

(71) Applicant: MITSUBISHI HEAVY INDUSTRIES COMPRESSOR CORPORATION, Tokyo (JP)

(72) Inventor: Koji Maeta, Tokyo (JP)

(73) Assignee: MITSUBISHI HEAVY INDUSTRIES COMPRESSOR CORPORATION, Tokyo (JP)

(21) Appl. No.: 17/911,534

(22) PCT Filed: Mar. 11, 2021
(86) PCT No.: PCT/JP2021/009806

§ 371 Date: Sep. 14, 2022

(30) Foreign Application Priority Data
Mar. 16, 2020 (JP) 2020-045650
Mar. 16, 2020 (JP) 2020-045777
Mar. 16, 2020 (JP) 2020-045783

(51) Int. Cl. F04D 29/66; F04D 29/44; H04R 3/00

(52) U.S. Cl. CPC F04D 29/664; F04D 29/665; F04D 29/441; H04R 3/002

(57) ABSTRACT

A compressor includes: a rotation shaft which is allowed to rotate around an axis; an impeller which is configured to pressure-feed a fluid from one side in an axial direction toward an outside in a radial direction by rotating together with the rotation shaft; a casing surrounding the rotation shaft and the impeller and in which an exit flow path guiding the fluid pressure-fed from the impeller is formed; and an acoustic liner which is installed to face an inside of the exit flow path in the casing. The acoustic liner includes: an acoustic space which is formed inside the acoustic liner; an introduction hole communicating the acoustic space with the exit flow path; and a vortex suppressor which is placed in a connection area between the introduction hole and the acoustic space and is configured to suppress vortexes which occur in the connection area.

### TECHNICAL FIELD

The present disclosure relates to a compressor.

Priority is claimed on Japanese Patent Application No. 2020-045777 filed on Mar. 16, 2020, Japanese Patent Application No. 2020-045783 filed on Mar. 16, 2020, and Japanese Patent Application No. 2020-045650 filed on Mar. 16, 2020 and the contents thereof are incorporated herein.

### BACKGROUND ART

In a turbo machine including a compressor, noise occur while rotation elements of the machine are operated. If such noise transmits to a stationary component, there is a risk that a structural failure of the stationary component may occur. Here, for the purpose of noise prevention, an acoustic liner being provided in an exit flow path of the compressor has been proposed (see Patent Document 1 below). The acoustic liner includes an introduction hole which is opened toward the flow path and an acoustic space which is connected to a downstream side of the introduction hole.

### CITATION LIST

### Patent Document(s)

Patent Document 1: US Patent No. 2002/0079158

### SUMMARY OF INVENTION

### Technical Problem

However, since the flow velocity in the flow path is high in the above-described compressor, the acoustic resistance becomes large when guiding sound waves from the introduction hole of the acoustic liner to the acoustic space. Specifically, vortexes occur in fluid to be compressed at an exit of the introduction hole (that is, an entrance of the acoustic space) and the vortexes prevent sound waves from being introduced to the acoustic space smoothly. As a result, there is a possibility that a sufficient sound reduction effect may not be obtained.

The present disclosure has been made to solve the above-described problems and an object thereof is to provide a compressor having an excellent noise-reduction property.

### Solution to Problem

In order to solve the above-described problems, a compressor according to the present disclosure includes: a rotation shaft which is allowed to rotate around an axis; an impeller which is configured to pressure-feed a fluid from one side in an axial direction toward an outside in a radial direction by rotating together with the rotation shaft; a casing surrounding the rotation shaft and the impeller and in which an exit flow path guiding the fluid pressure-fed from the impeller is formed; and an acoustic liner which is installed to face an inside of the exit flow path in the casing, wherein the acoustic liner includes an acoustic space which is formed inside the acoustic liner, an introduction hole communicating the acoustic space with the exit flow path, and a vortex suppressor which is placed in a connection area between the introduction hole and the acoustic space and is configured to suppress vortexes which occur in the connection area.

A compressor according to the present disclosure includes: a rotation shaft which is allowed to rotate around an axis; an impeller which is configured to pressure-feed a fluid from one side in an axial direction toward an outside in a radial direction by rotating together with the rotation shaft; a casing surrounding the rotation shaft and the impeller and in which an exit flow path guiding the fluid pressure-fed from the impeller is formed; and an acoustic liner which is installed to face an inside of the exit flow path in the casing, wherein the acoustic liner includes an acoustic space which is formed inside the acoustic liner, and a plurality of introduction holes communicating the acoustic space with the exit flow path, and wherein the plurality of introduction holes are formed to communicate with the acoustic space while coming closer to each other as the introduction holes are extended from the exit flow path toward the acoustic space and performs as a vortex suppressor suppressing vortexes which occur in a connection area between the plurality of introduction holes and the acoustic space.

A compressor according to the present disclosure includes: a rotation shaft which is allowed to rotate around an axis; an impeller which is configured to pressure-feed a fluid from one side in an axial direction toward an outside in a radial direction by rotating together with the rotation shaft; a casing surrounding the rotation shaft and the impeller and in which a diffuser flow path guiding the fluid pressure-fed from the impeller toward an outside in a radial direction is formed; and a plurality of diffuser vanes which are provided in the diffuser flow path at intervals in a circumferential direction of the axis, wherein each of the diffuser vanes includes a vane body extending toward a rotation direction of the rotation shaft as the diffuser vane is extended toward an outside in a radial direction and a sound reducer which is formed on a surface of the vane body.

A compressor according to the present disclosure includes: a rotation shaft which is allowed to rotate around an axis; an impeller which is configured to pressure-feed a fluid from one side in an axial direction toward an outside in a radial direction by rotating together with the rotation shaft; a casing surrounding the rotation shaft and the impeller and in which an exit flow path guiding the fluid pressure-fed from the impeller is formed; a speaker wall which is provided to face an inside of the exit flow path in the casing; a pressure sensor which is configured to detect a pressure inside the exit flow path; and a computing device which is configured to send a signal to the speaker wall to emit a sound having a frequency for canceling a target sound on the basis of a detection value of the pressure sensor.

### Advantageous Effects of Invention

According to the present disclosure, it is possible to provide a compressor having exceptional noise-reduction properties.

### BRIEF DESCRIPTION OF DRAWINGS

FIG. 1 is a cross-sectional view showing a configuration of a compressor according to a first embodiment of the present disclosure.

FIG. 2 is a perspective view showing a configuration of an acoustic liner according to the first embodiment of the present disclosure.

FIG. 3 is a cross-sectional view showing the configuration of the acoustic liner according to the first embodiment of the present disclosure.

FIG. 4 is a cross-sectional view showing a configuration of an acoustic liner according to a second embodiment of the present disclosure.

FIG. 5 is a cross-sectional view showing a modified example of the acoustic liner according to the second embodiment of the present disclosure.

FIG. 6 is a cross-sectional view showing a configuration of an acoustic liner according to a third embodiment of the present disclosure.

FIG. 7 is a cross-sectional view showing a configuration of a compressor according to a fourth embodiment of the present disclosure.

FIG. 8 is a cross-sectional view showing a configuration of a sound reducer according to the fourth embodiment of the present disclosure.

FIG. 9 is a cross-sectional view showing a configuration of a sound reducer according to a fifth embodiment of the present disclosure.

FIG. 10 is an explanatory diagram showing a behavior of the sound reducer according to the fifth embodiment of the present disclosure.

FIG. 11 is a cross-sectional view showing a configuration of a compressor according to a sixth embodiment of the present disclosure.

FIG. 12 is a cross-sectional view showing a configuration of a speaker wall according to the sixth embodiment of the present disclosure.

FIG. 13 is a hardware configuration diagram of a computing device according to the sixth embodiment of the present disclosure.

FIG. 14 is a functional block diagram of the computing device according to the sixth embodiment of the present disclosure.

FIG. 15 is a plan view of a speaker wall according to a seventh embodiment of the present disclosure.

### DESCRIPTION OF EMBODIMENTS

### First Embodiment

(Configuration of Compressor)

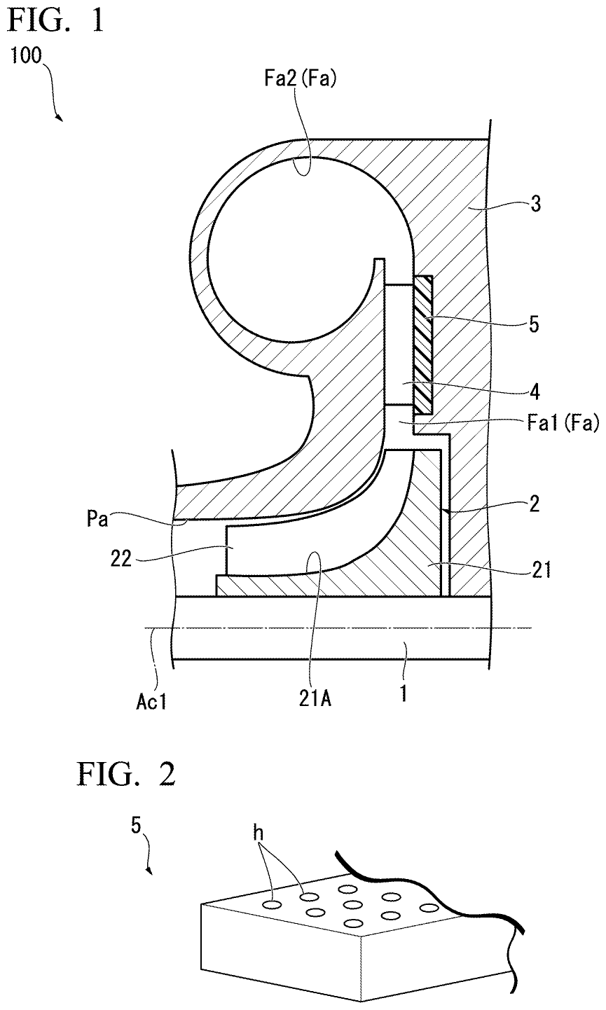

Hereinafter, a compressor 100 according to a first embodiment of the present disclosure will be described with reference to FIGS. 1 to 3. As shown in FIG. 1, the compressor 100 includes a rotation shaft 1, an impeller 2, a casing 3, a return vane 4, and an acoustic liner 5.

The rotation shaft 1 extends along an axis Ac1 and is rotatable around the axis Ac1. The impeller 2 is fixed to the outer peripheral surface of the rotation shaft 1. The impeller 2 includes a disk 21 and a plurality of blades 22. The disk 21 is formed in a disk shape centered on the axis Ac1. An outer peripheral surface (main surface 21A) of the disk 21 is formed in a curved surface shape which is curved from the inside toward the outside in the radial direction as the outer peripheral surface is expanded from one side toward the other side in the direction of the axis Ac1.

A plurality of blades 22 are provided on the main surface 21A at intervals in the circumferential direction. Although not shown in detail, each blade 22 is curved from the front side toward the rear side in the rotation direction of the rotation shaft 1 as the blade is extended from the inside toward the outside in the radial direction. The impeller 2 rotates together with the rotation shaft 1 to pressure-feed a fluid, introduced from one side in the direction of the axis Ac1, toward the outside in the radial direction.

The casing 3 surrounds the rotation shaft 1 and the impeller 2 from the outer peripheral side. A compression flow path Pa, for compressing a fluid introduced from the outside of the casing 3, in which the impeller 2 is accommodated and an exit flow path Fa which is connected to the radial outside of the compression flow path Pa are formed inside the casing 3. The compression flow path Pa gradually increases in its diameter, corresponding to the outer shape of the impeller 2, as the compression flow path is expanded from one side toward the other side in the direction of the axis Ac1. The exit flow path Fa is connected to the radially outer exit of the compression flow path Pa.

The exit flow path Fa includes a diffuser flow path Fa1 and an exit scroll Fa2. The diffuser flow path Fa1 is provided to recover the static pressure of the fluid introduced from the compression flow path Pa. The diffuser flow path Fa1 is formed in an annular shape which extends from the exit of the compression flow path Pa toward the outside in the radial direction. In the cross-sectional view including the axis Ac1, the flow path width of the diffuser flow path Fa1 is constant over the entire area in the extending direction. The plurality of return vanes 4 are provided in the diffuser flow path Fa1. The plurality of these return vanes 4 are arranged at intervals in the circumferential direction.

The exit scroll Fa2 is connected to the radially outer exit of the diffuser flow path Fa1. The exit scroll Fa2 is formed in a swirl shape extending in the circumferential direction of the axis Ac1. The exit scroll Fa2 has a circular flow path cross-section. Part of the exit scroll Fa2 is provided with an exhaust hole for guiding a high-pressure fluid to the outside (not shown).

(Configuration of Acoustic Liner)

The acoustic liner 5 is provided on the wall surface on the other side of the direction of the axis Ac1 in the diffuser flow path Fa1. The acoustic liner 5 is embedded in this wall surface to face the diffuser flow path Fa1. The acoustic liner 5 is formed in an annular shape centered on the axis Ac1. The acoustic liner 5 is provided to absorb and reduce noise caused by the fluid flowing through the diffuser flow path Fa1.

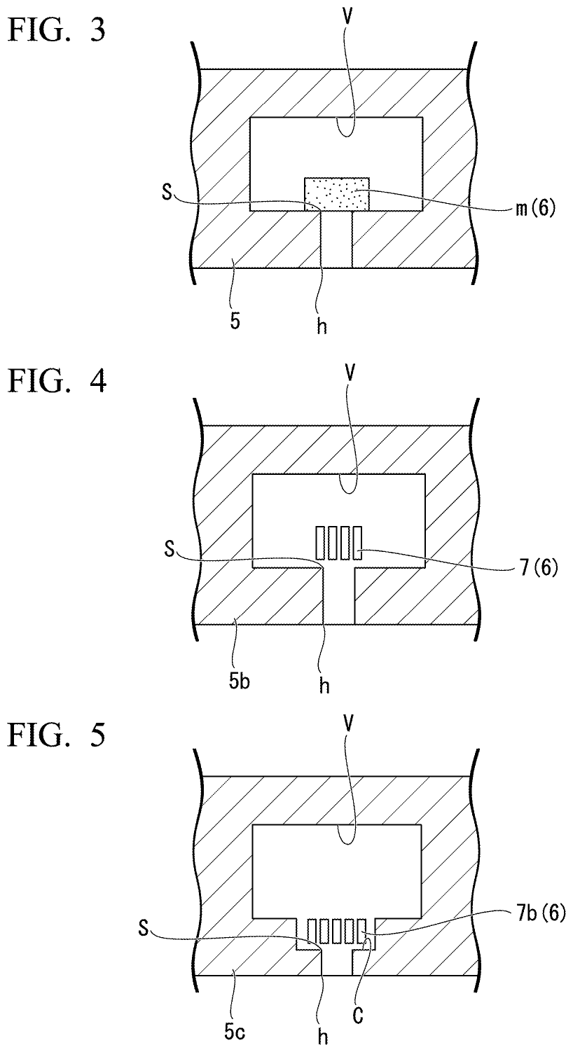

As shown in FIG. 2, the acoustic liner 5 is formed in a plate shape and one side surface thereof is provided with a plurality of introduction holes h which are opened in the diffuser flow path Fa1. More specifically, as shown in FIG. 3, the acoustic liner 5 includes an acoustic space V, the introduction hole h, and a vortex suppressor 6 which are formed therein.

The acoustic space V is a space formed inside the acoustic liner 5. The introduction hole h communicates the diffuser flow path Fa1 with the acoustic space V. A plurality of pairs of such acoustic spaces V and introduction holes h are formed inside the acoustic liner 5 over the entire extension area.

The vortex suppressor 6 is provided at a connection area (throat portion S) between the introduction hole h and the acoustic space V. The vortex suppressor 6 is provided to reduce and suppress vortexes which occur when a sound wave introduces from the introduction hole h into the acoustic space V. In this embodiment, the vortex suppressor 6 which is formed of a foam metal m is provided to cover the introduction hole h from the side of the acoustic space V.

(Operation and Effect)

Next, the operation of the compressor 100 will be described. When operating the compressor 100, the rotation shaft 1 is first rotated around the axis Ac1 by an external drive source. As the rotation shaft 1 rotates, the impeller 2 also rotates such that an external fluid is introduced to the compression flow path Pa. The fluid guided to the blades 22 of the impeller 2 in the compression flow path Pa is compressed by a centrifugal force to a high pressure state. This high-pressure flow path is taken out to the outside through the diffuser flow path Fa1 and the exit scroll Fa2.

Here, noise occurs while the impeller 2 rotates in the compressor 100. Among such noise, especially the noise called NZ sound is likely to cause resonance with each part of the compressor 100. As a result, it is important to reduce and suppress the noise. The NZ sound is noise (discrete frequency sound) of a frequency based on the sum of the number of blades (that is, the number of blades 22) N of the impeller 2 and the number of revolutions Z of the rotation shaft 1.

For the purpose of reducing and suppressing such NZ sound, the acoustic liner 5 is provided in the diffuser flow path Fa1 in this embodiment. The sound wave which is introduced into the acoustic space V through the introduction hole h is attenuated inside the acoustic space V. Accordingly, it is possible to suppress the leakage of noise to the outside.

Incidentally, since the flow velocity of the fluid is high in the diffuser flow path Fa1, acoustic resistance is increased when the sound wave is introduced from the introduction hole h of the acoustic liner 5 to the acoustic space V. Specifically, vortexes occur in the fluid at the exit of the introduction hole h (that is, the throat portion S) and the vortexes prevent the sound wave from introducing to the acoustic space smoothly. As a result, there is a possibility that a sufficient sound reduction effect may not be obtained.

However, according to the above-described configuration, since the throat portion S is provided with the vortex suppressor 6, it prevents vortexes from occurring inside the acoustic space V. Accordingly, the resistance (acoustic resistance) generated when the sound wave is introduced to the introduction hole h is reduced. As a result, since the sound wave is likely to be introduced into the acoustic liner 5, it is possible to more efficiently absorb and reduce noise.

Particularly, in the above-described configuration, the vortex suppressor 6 formed of the foam metal m is provided to cover the introduction hole h. Since the vortexes are dispersed by the foam metal m, it is possible to significantly reduce the resistance (acoustic resistance) generated when the sound wave introduces to the introduction hole h. Accordingly, it is possible to significantly reduce the noise of the compressor 100.

### Second Embodiment

Next, a second embodiment of the present disclosure will be described with reference to FIG. 4. Additionally, the same reference numerals will be given to the same configurations as those of the above-described first embodiment and detailed descriptions thereof will be omitted. As shown in the same drawing, in the acoustic liner 5b according to this embodiment, a plurality of plate members 7 are provided in the throat portion S as the vortex suppressor 6. These plate members 7 extend from the introduction hole h toward the acoustic space V and are arranged at intervals in a direction including a plane orthogonal to the extending direction of the introduction hole h. Accordingly, a plurality of slits are formed between the plate members 7.

According to the above-described configuration, since the vortexes are dispersed when passing through the slits as the vortex suppressor, it is possible to reduce the resistance (acoustic resistance) when the sound wave introduces to the introduction hole. As a result, since the sound wave is likely to be introduced into the acoustic liner 5b, it is possible to more efficiently absorb and reduce noise.

Additionally, a configuration shown in FIG. 5 can be also adopted as a modified example of the second embodiment. In an acoustic liner 5c of the same drawing, a cavity C having an opening area larger than that of the introduction hole h is formed at a portion of the introduction hole h on the side of the acoustic space V. The plurality of plate members 7b are arranged inside the cavity C similarly as described above. A plurality of slits are formed between these plate members 7b.

According to the above-described configuration, since the vortexes are dispersed when passing through the slits as the vortex suppressor 6, it is possible to reduce the resistance (acoustic resistance) when the sound wave introduces to the introduction hole h. Also, since the plate members 7b forming the slits are placed inside the cavity C, it is possible to secure a large effective volume as the acoustic space V. Accordingly, it is possible to significantly reduce noise.

### Third Embodiment

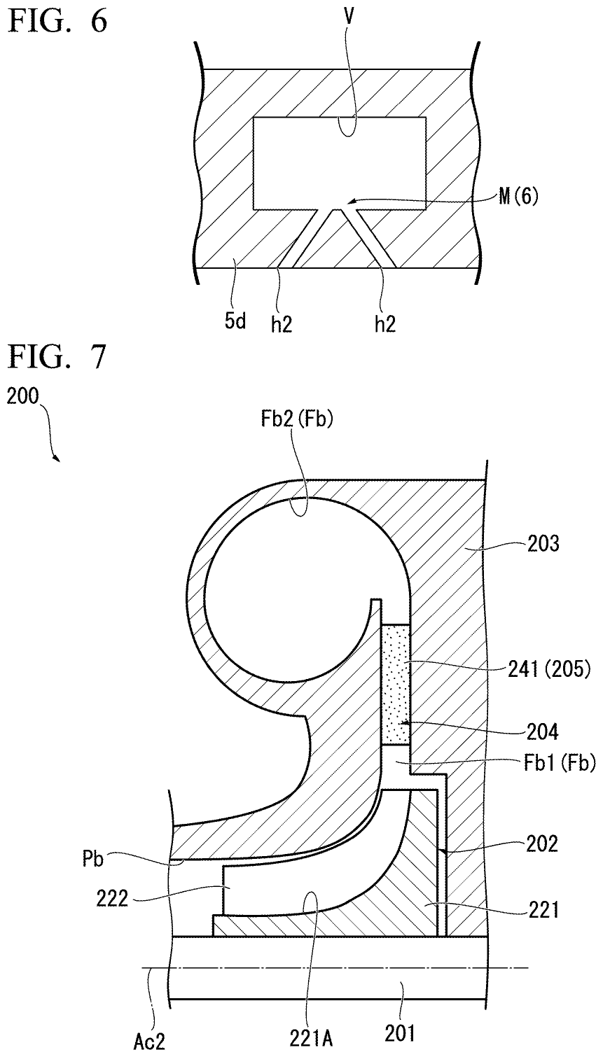

Next, a third embodiment of the present disclosure will be described with reference to FIG. 6. Additionally, the same reference numerals will be given to the same configurations as those of the above-described embodiments and detailed description thereof will be omitted. As shown in the same drawing, in an acoustic liner 5d according to this embodiment, a plurality of (two as an example) introduction holes h2 are formed in each acoustic space V. These plurality of introduction holes h2 are extend to come closer to each other as the introduction holes are extended from the side of the diffuser flow path Fa1 toward the side of the acoustic space V. These introduction holes h2 come into contact with each other inside the acoustic space V to form a junction M which is the vortex suppressor 6 for suppressing occurrence of the vortexes of the fluid in the connection area between the plurality of introduction holes h2 and the acoustic space V. The vortex suppressor 6 is formed to reduce and suppress the vortexes which occur when the sound wave introduces from the plurality of introduction holes h2 into the acoustic space V.

According to the above-described configuration, the sound waves from the plurality of introduction holes h2 interfere with each other when introducing to the acoustic space V. Accordingly, the occurrence of the vortexes of the fluid is suppressed and thereby the resistance (acoustic resistance) generated when the sound wave introduces to the introduction hole h2 is reduced. As a result, since the sound wave is likely to be introduced into the acoustic liner 5d, it is possible to more efficiently absorb and reduce noise.

### Fourth Embodiment

(Configuration of Compressor)

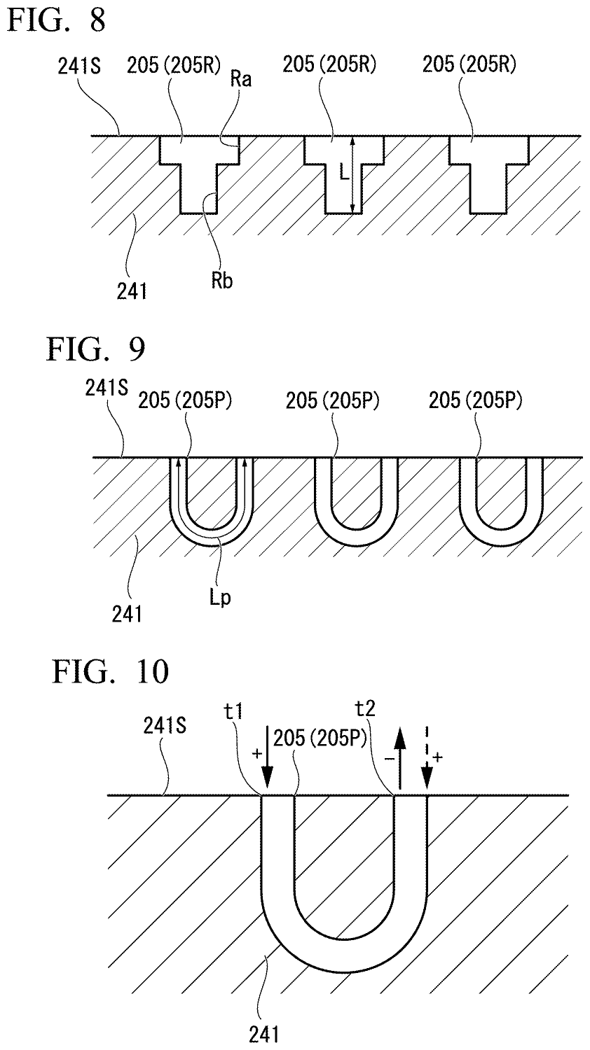

Next, a compressor 200 according to a fourth embodiment of the present disclosure will be described with reference to FIGS. 7 and 8. As shown in FIG. 7, the compressor 200 includes a rotation shaft 201, an impeller 202, a casing 203, and a diffuser vane 204.

The rotation shaft 201 extends along an axis Ac2 and is rotatable around the axis Ac2. The impeller 202 is fixed to the outer peripheral surface of the rotation shaft 201. The impeller 202 includes a disk 221 and a plurality of blades 222. The disk 221 is formed in a disk shape centered on the axis Ac2. The outer peripheral surface (main surface 221A) of the disk 221 is formed in a curved surface shape which is curved from the inside toward the outside in the radial direction as the outer peripheral surface is expanded from one side toward the other side in the direction of the axis Ac2.

The plurality of blades 222 are provided on the main surface 221A at intervals in the circumferential direction. Although not shown in detail, each blade 222 is curved from the front side toward the rear side in the rotation direction of the rotation shaft 201 as the blade is extended from the inside toward the outside in the radial direction. The impeller 202 rotates together with the rotation shaft 201 to pressure-feed a fluid, introduced from one side in the direction of the axis Ac2, toward the outside in the radial direction.

The casing 203 surrounds the rotation shaft 201 and the impeller 202 from the outer peripheral side. A compression flow path Pb, for compressing a fluid introduced from the outside of the casing 203, in which the impeller 202 is accommodated and an exit flow path Fb which is connected to the radial outside of the compression flow path Pb are formed inside the casing 203. The compression flow path Pb gradually increases in its diameter, corresponding to the outer shape of the impeller 202, as the compression flow path is expanded from one side toward the other side in the direction of the axis Ac2. The exit flow path Fb is connected to the radial outside of the exit of the compression flow path Pb.

The exit flow path Fb includes a diffuser flow path Fb1 and an exit scroll Fb2. The diffuser flow path Fb1 is provided to recover the static pressure of the fluid introduced from the compression flow path Pb. The diffuser flow path Fb1 is formed in an annular shape which extends from the exit of the compression flow path Pb toward the outside in the radial direction. In the cross-sectional view including the axis Ac2, the flow path width of the diffuser flow path Fb1 is constant over the entire area in the extending direction. The plurality of diffuser vanes 204 are provided in the diffuser flow path Fb1. The configuration of the diffuser vane 204 will be described later.

The exit scroll Fb2 is connected to the radial outside of the exit of the diffuser flow path Fb1. The exit scroll Fb2 is formed in a swirl shape extending in the circumferential direction of the axis Ac2. The exit scroll Fb2 has a circular flow path cross-section. Part of the exit scroll Fb2 is provided with an exhaust hole for guiding a high-pressure fluid to the outside (not shown).

(Configuration of Diffuser Vane)

The plurality of diffuser vanes 204 are arranged in the diffuser flow path Fb1 at intervals in the circumferential direction. Each diffuser vane 204 includes a vane body 241 extending toward the rotation direction of the rotation shaft 201 as the vane body is extended outward in the radial direction and a sound reducer 205 which is formed on a surface 241S of the vane body 241.

As shown in FIG. 8, the sound reducer 205 according to this embodiment is a plurality of recessed portions 205R which are arranged at intervals on the surface 241S of the vane body 241. Each recessed portion 205R is recessed from the surface 241S toward the inside of the vane body 241. The cross-sectional area of the portion (entrance portion Ra) on the side of the surface 241S of the recessed portion 205R is larger than that of the other portion (bottom portion Rb). Also, a step is formed between the entrance portion Ra and the bottom portion Rb. The cross-sectional area of the entrance portion Ra is constant over the entire area in the extending direction and the cross-sectional area of the bottom portion Rb is also constant over the entire area in the extending direction.

The depth L of the recessed portion 205R from the surface 241S (that is, the sum of the length of the entrance portion Ra and the bottom portion Rb) is a quarter length of the wavelength λ of the sound to be reduced. That is, L=(¼)×λ.

(Operation and Effect)

Next, the operation of the compressor 200 will be described. When operating the compressor 200, the rotation shaft 201 is first rotated around the axis Ac2 by an external drive source. As the rotation shaft 201 rotates, the impeller 202 also rotates, so that an external fluid is introduced to the compression flow path Pb. The fluid guided to the blades 222 of the impeller 202 in the compression flow path Pb is compressed by a centrifugal force to a high pressure state. This high-pressure flow path is taken out to the outside through the diffuser flow path Fb1 and the exit scroll Fb2.

Here, noise occurs while the impeller 202 rotates in the compressor 200. Among such noise, especially the noise called NZ sound is likely to cause resonance with each part of the compressor 200. As a result, it is important to reduce and suppress the noise. The NZ sound is noise (discrete frequency sound) of a frequency based on the sum of the number of blades (that is, the number of blades 222) N of the impeller 202 and the number of revolutions Z of the rotation shaft 201.

For the purpose of reducing and suppressing such NZ sound, the sound reducer 205 is provided in the vane body 241 disposed in the exit flow path Fb in this embodiment. Accordingly, it is possible to absorb and reduce noise when the fluid passes through the surface 241S of the vane body 241.

According to the above-described configuration, the sound wave is trapped in the recessed portion 205R which is the sound reducer 205 and is attenuated inside the recessed portion 205R. Accordingly, it is possible to reduce the leakage of noise to the outside.

According to the above-described configuration, a non-reflective boundary condition in which Zi is equal to pc is realized at the entrance of the recessed portion 205R by setting the depth L of the recessed portion 205R from the surface 241S to a quarter of the wavelength λ of the sound at the frequency to be reduced. Additionally, Zi is the acoustic impedance, ρ is the density, and c is the speed of sound. Accordingly, the sound wave of the reduction target frequency trapped by the recessed portion 205R can be attenuated without being reflected to the outside.

According to the above-described configuration, the cross-sectional area of the portion (entrance portion Ra) on the side of the surface 241S of the recessed portion 205R is larger than that of the other portion (bottom portion Rb). Accordingly, it is possible to trap the sound wave in a wider area of the surface 241S of the vane body 241.

### Fifth Embodiment

Next, a fifth embodiment of the present disclosure will be described with reference to FIGS. 9 and 10. Additionally, the same reference numerals will be given to the same configurations as those of the fourth embodiment and detailed description thereof will be omitted. As shown in FIG. 9, in this embodiment, a plurality of passages 205P are formed on the surface 241S of the vane body 241 which is the sound reducer 205. Both ends of the passage 205P are opened to the surface 241S. That is, the passage 205P has a U shape in a cross-sectional view. The length Lp (that is, the length from one end t1 to the other end t2) of the passage 205P is set to twice the wavelength λ of the sound to be reduced (Lp=2×λ).

According to the above-described configuration, the phase of the sound wave is changed in the passage 205P and radiated from the other end t2 by introducing the sound wave from one end t1 of the passage 205P. Since the sound wave radiated from the other end t2 interferes with the sound wave incident on the other end t2, the sound wave can be attenuated.

Particularly, according to the above-described configuration, the length of the passage 205P is twice the wavelength of the sound to be reduced. Accordingly, a sound (for example, a sound with a positive phase: the solid line arrow in FIG. 10) entering the passage 205P from one end t1 is radiated from the other end t2 as a sound with a negative phase. Accordingly, it is possible to cancel the positive phase sound (broken line arrow in FIG. 10) entering the other end t2. As a result, it is possible to significantly reduce noise of the compressor 200.

### Sixth Embodiment

(Configuration of Compressor)

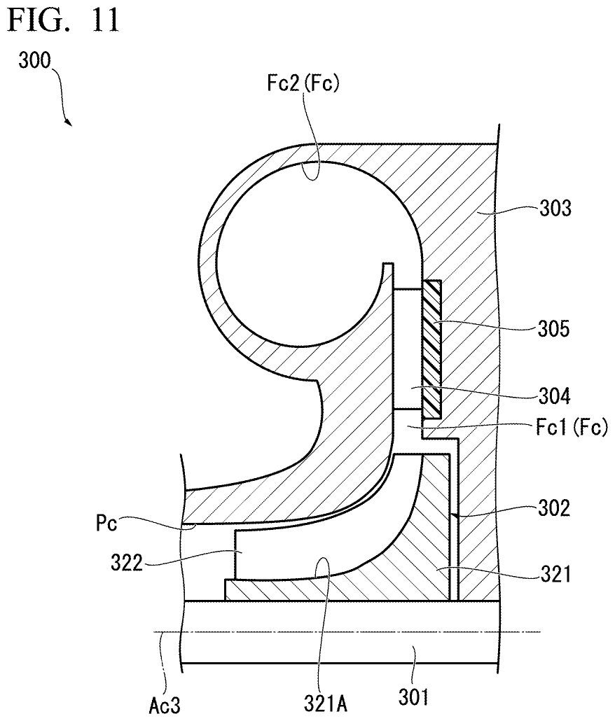

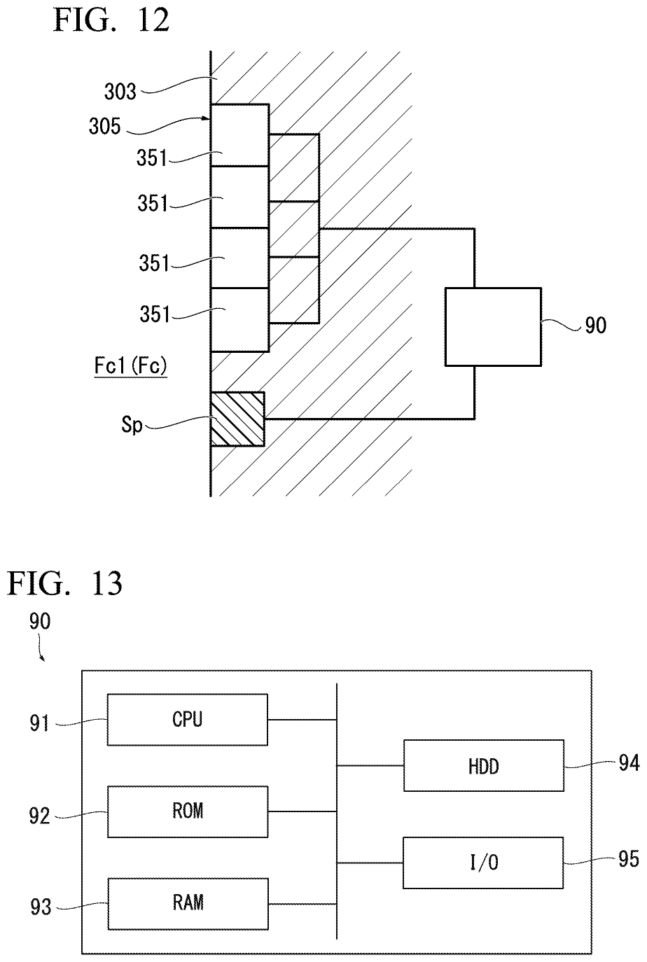

Next, a compressor 300 according to a sixth embodiment of the present disclosure will be described with reference to FIGS. 11 to 13. As shown in FIG. 11 or 12, the compressor 300 includes a rotation shaft 301, an impeller 302, a casing 303, a diffuser vane 304, a speaker wall 305, a pressure sensor Sp, and a computing device 90.

As shown in FIG. 11, the rotation shaft 301 extends along an axis Ac3 and is rotatable around the axis Ac3. The impeller 302 is fixed to the outer peripheral surface of the rotation shaft 301. The impeller 302 includes a disk 321 and a plurality of blades 322. The disk 321 is formed in a disk shape centered on the axis Ac3. The outer peripheral surface (main surface 321A) of the disk 321 is formed in a curved surface shape which is curved from the inside toward the outside in the radial direction as the outer peripheral surface is expanded from one side toward the other side in the direction of the axis Ac3.

A plurality of blades 322 are provided on the main surface 321A at intervals in the circumferential direction. Although not shown in detail, each blade 322 is curved from the front side toward the rear side in the rotation direction of the rotation shaft 301 as the blade is extended from the inside toward the outside in the radial direction. The impeller 302 rotates together with the rotation shaft 301 to pressure-feed a fluid, introduced from one side in the direction of the axis Ac3, toward the outside in the radial direction.

The casing 303 surrounds the rotation shaft 301 and the impeller 302 from the outer peripheral side. A compression flow path Pc, for compressing a fluid introduced from the outside of the casing 303, in which the impeller 302 is accommodated and an exit flow path Fc which is connected to the radial outside of the compression flow path Pc are formed inside the casing 303. The compression flow path Pc gradually increases in its diameter, corresponding to the outer shape of the impeller 302, as the compression flow path is expanded from one side toward the other side in the direction of the axis Ac3. The exit flow path Fc is connected to the radial outside of the compression flow path Pc.

The exit flow path Fc includes a diffuser flow path Fc1 and an exit scroll Fc2. The diffuser flow path Fc1 is provided to recover the static pressure of the fluid introduced from the compression flow path Pc. The diffuser flow path Fc1 is formed in an annular shape which extends from the exit of the compression flow path Pc toward the outside in the radial direction. In the cross-sectional view including the axis Ac3, the flow path width of the diffuser flow path Fc1 is constant over the entire area in the extending direction. The plurality of diffuser vanes 304 are provided in the diffuser flow path Fc1. The plurality of these diffuser vanes 304 are arranged at intervals in the circumferential direction.

The exit scroll Fc2 is connected to the radially outer exit of the diffuser flow path Fc1. The exit scroll Fc2 is formed in a swirl shape extending in the circumferential direction of the axis Ac3. The exit scroll Fc2 has a circular flow path cross-section. Part of the exit scroll Fc2 is provided with an exhaust hole for guiding a high-pressure fluid to the outside (not shown).

(Configuration of Speaker Wall)

The speaker wall 305 is provided on the wall surface at the other side in the direction of the axis Ac3 in the diffuser flow path Fc1. The speaker wall 305 is embedded in this wall surface to face the diffuser flow path Fc1. The speaker wall 305 has an annular shape centered on the axis Ac3. The speaker wall 305 is provided to reduce noise caused by the fluid flowing through the diffuser flow path Fc1.

As shown in FIG. 12, the speaker wall 305 has a plate shape and includes a plurality of speaker elements 351 arranged in the radial direction and the circumferential direction. The computing device 90 is connected to each speaker element 351 via a signal line. Also, a pressure sensor Sp is provided below these speaker elements 351 (that is, the upstream side of the speaker wall 305 in the diffuser flow path Fc1). The pressure sensor Sp detects noise in the diffuser flow path Fc1 as pressure fluctuations and sends the detection result to the computing device 90 as an electrical signal.

(Configuration of Computing Device)

The computing device 90 sends a signal to the speaker element 351 to emit a sound (canceling sound) having a frequency that cancels out a target sound (that is, a sound having a frequency to be reduced) on the basis of the detection value of the pressure sensor Sp.

As shown in FIG. 13, the computing device 90 is a computer including a CPU 91 (Central Processing Unit), a ROM 92 (Read Only Memory), a RAM 93 (Random Access Memory), an HDD 94 (Hard Disk Drive), and a signal transmission/reception module 95 (I/O: Input/Output). The signal transmission/reception module 95 receives the value of the pressure of the diffuser flow path Fc1 detected by the pressure sensor Sp as an electrical signal. Also, the signal transmission/reception module 95 transmits an electrical signal for outputting the canceling sound to the speaker element 351. Additionally, the signal transmission/reception module 95 may transmit and receive an amplified signal via, for example, a charge amplifier or the like.

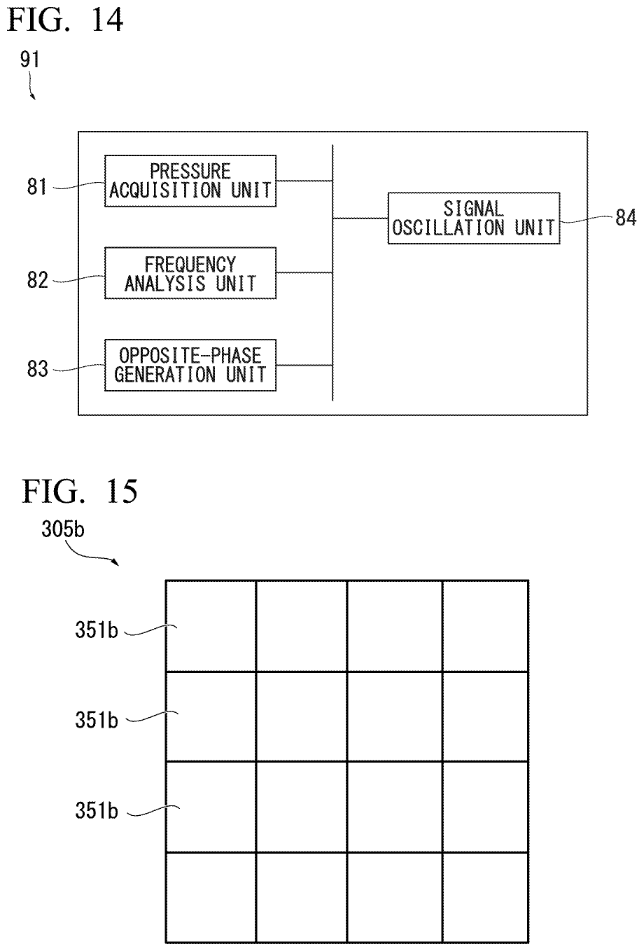

As shown in FIG. 14, the CPU 91 of the computing device 90 includes a pressure acquisition unit 81, a frequency analysis unit 82, an opposite-phase generation unit 83, and a signal oscillation unit 84 by executing a program stored in advance in the device itself. The pressure acquisition unit 81 receives a sound as the pressure value detected by the pressure sensor Sp. The frequency analysis unit 82 analyzes the frequency of the input sound and determines the frequencies to be reduced. The opposite-phase generation unit 83 generates a sound (canceling sound) having a frequency opposite in phase to that of the target sound. The signal oscillation unit 84 outputs an electrical signal to the speaker element 351 to output the canceling sound to each speaker element 351.

(Operation and Effect)

Next, the operation of the compressor 300 will be described. When operating the compressor 300, the rotation shaft 301 is first rotated around the axis Ac3 by an external drive source. As the rotation shaft 301 rotates, the impeller 302 also rotates, so that an external fluid is introduced to the compression flow path Pc. The fluid guided to the blades 322 of the impeller 302 in the compression flow path Pc is compressed by a centrifugal force to a high pressure state. This high-pressure flow path is taken out to the outside through the diffuser flow path Fc1 and the exit scroll Fc2.

Here, noise occur while the impeller 302 rotates in the compressor 300. Among such noise, especially the noise called NZ sound is likely to cause resonance with each part of the compressor 300. As a result, it is important to reduce and suppress the noise. The NZ sound is noise (discrete frequency sound) of a frequency based on the sum of the number of blades (that is, the number of blades 322) N of the impeller 302 and the number of revolutions Z of the rotation shaft 301.

For the purpose of reducing and suppressing such NZ sound, the speaker wall 305 is provided in the diffuser flow path Fc1 in this embodiment. According to the above-described configuration, the speaker wall 305 emits a sound having a frequency that cancels out the sound as the pressure fluctuation detected by the pressure sensor Sp. This sound can cancel the noise in the exit flow path Fc. Also, even if the frequency of the noise changes with time, the pressure sensor Sp immediately detects this change, and the computing device 90 generates a sound for having a frequency canceling another sound having different frequency. Accordingly, the noise reduced state can be maintained autonomously regardless of the operating state of the compressor 300.

According to the above-described configuration, the frequency analysis unit 82 determines a target sound based on the detection value of the pressure sensor Sp, and the opposite-phase generation unit 83 generates a sound having a frequency opposite in phase to that of the target sound. The signal oscillation unit 84 transmits a signal to the speaker wall 305 to emit the opposite-phase sound. Accordingly, noise of a specific frequency can be selectively and effectively reduced.

### Seventh Embodiment

Next, a seventh embodiment of the present disclosure will be described with reference to FIG. 15. Additionally, the same reference numerals will be given to the same configurations as those of the above-described sixth embodiment and detailed description thereof will be omitted. As shown in the same drawing, in this embodiment, canceling sounds of which frequencies are different from each other are emitted from the plurality of speaker elements 351b of the speaker wall 305b. The opposite-phase generation unit 83 generates the canceling sounds having frequencies opposite in phase to those of a plurality of target sounds. The signal oscillation unit 84 sends signals to the speaker elements 351b to emit the canceling sounds. For example, a particular speaker element 351b emits a canceling sound of which frequency is 2 kHz, and a different speaker element 351b emits another canceling sound of which frequency is 2.1 kHz.

According to the above-described configuration, the opposite-phase generation unit 83 generates the canceling sounds having frequencies opposite in phase to those of the target sounds. The signal oscillation unit 84 makes the speaker elements 351b emit the canceling sounds having frequencies opposite in phase to those of the target sounds. Thus, it is possible to reduce the noise which occurs in the exit flow path Fc in every frequency bands. As a result, it is possible to significantly suppress the noise of the compressor 300.

### Other Embodiments

The embodiments of the present disclosure have been described above. Additionally, various changes and modifications can be made to the above-described configuration without departing from the gist of the present disclosure. For example, it is also possible to apply a combination of different types of vortex suppressors 6 described in the first to third embodiments and the configuration of the introduction hole h2 described in the third embodiment to one acoustic liner 5.

For example, it is also possible to apply a combination of different types of sound reducers 205 (the recessed portion 205R and the passage 205P) described in the fourth and fifth embodiments to one vane body 241.

### APPENDIX

The compressors 100, 200, and 300 described in the embodiments are understood as follows, for example.

(1) The compressor 100 according to a first aspect includes: the rotation shaft 1 which is allowed to rotate around the axis Ac1; the impeller 2 which is configured to pressure-feed a fluid from one side in the direction of the axis Ac1 toward the outside in the radial direction by rotating together with the rotation shaft 1; the casing 3 surrounding the rotation shaft 1 and the impeller 2 and in which exit flow path Fa guiding the fluid pressure-fed from the impeller 2 is formed; and the acoustic liner 5 which is installed to face the inside of the exit flow path Fa in the casing 3, wherein the acoustic liner 5 includes the acoustic space V which is formed inside the acoustic liner 5, the introduction hole h communicating the acoustic space V with the exit flow path Fa, and the vortex suppressor 6 which is placed in a connection area between the introduction hole h and the acoustic space V and is configured to suppress vortexes which occur in the connection area.

According to the above-described configuration, since the vortex suppressor 6 is provided, the occurrence of the vortexes of the fluid in the acoustic space V is suppressed. Accordingly, the resistance (acoustic resistance) generated when the sound wave introduces to the introduction hole h is reduced. As a result, it is possible to more efficiently absorb and attenuate the sound wave by the acoustic liner 5.

(2) In the compressor 100 according to a second aspect, the vortex suppressor 6 is formed of the foam metal m and covering the introduction hole h inside the acoustic space V.

According to the above-described configuration, the vortex suppressor 6 formed of the foam metal m is installed to cover the introduction hole h. Since the vortexes are dispersed by the foam metal m, it is possible to reduce the resistance (acoustic resistance) generated when the sound wave introduces to the introduction hole h.

(3) In the compressor 100 according to a third aspect, the vortex suppressor 6 includes a plurality of plate members 7 extending from the introduction hole h toward the acoustic space V and between which a plurality of slits are formed.

According to the above-described configuration, since the vortexes are dispersed when passing through the slits as the vortex suppressor 6, it is possible to reduce the resistance (acoustic resistance) when the sound wave introduces to the introduction hole h.

(4) In the compressor 100 according to a fourth aspect, the cavity C having an opening area larger than that of the introduction hole h is formed at a portion of the introduction hole h on the side of the acoustic space V and the vortex suppressor 6 is placed inside the cavity C and includes a plurality of plate members 7b extending from the introduction hole h toward the acoustic space V and between which a plurality of slits are formed.

According to the above-described configuration, since the vortexes are dispersed when passing through the slits as the vortex suppressor 6, it is possible to reduce the resistance (acoustic resistance) when the sound wave introduces to the introduction hole h. Also, since the plate members 7b forming the slits are placed inside the cavity C, it is possible to secure for cavity C a large effective volume as the acoustic space V. Accordingly, it is possible to significantly reduce noise.

(5) The compressor 100 according to a fifth aspect includes: the rotation shaft 1 which is allowed to rotate around the axis Ac1; the impeller 2 which is configured to pressure-feed a fluid from one side in the direction of the axis Ac1 toward the outside in the radial direction by rotating together with the rotation shaft 1; the casing 3 surrounding the rotation shaft 1 and the impeller 2 and in which the exit flow path Fa guiding the fluid pressure-fed from the impeller 2 is formed; and the acoustic liner 5d which is installed to face the inside of the exit flow path Fa in the casing 3, wherein the acoustic liner 5 includes the acoustic space V which is formed inside the acoustic liner 5 and the plurality of introduction holes h2 communicating the acoustic space V with the exit flow path Fa, and the plurality of introduction holes h2 are formed to communicate with the acoustic space V while coming closer to each other as the introduction holes are extended from the exit flow path Fa toward the acoustic space V and perform as the vortex suppressor 6 suppressing vortexes which occur in a connection area between the plurality of introduction holes h2 and the acoustic space V.

According to the above-described configuration, the sound waves from the plurality of introduction holes h2 interfere with each other when introducing to the acoustic space V. Accordingly, the occurrence of the vortexes of the fluid is suppressed and thereby the resistance (acoustic resistance) generated when the sound wave introduces to the introduction hole h2 is reduced. As a result, it is possible to more efficiently absorb and reduce the sound wave by the acoustic liner 5d.

(6) The compressor 200 according to a sixth aspect includes: the rotation shaft 201 which is allowed to rotate around the axis Ac2; the impeller 202 which is configured to pressure-feed a fluid from one side in the direction of the axis Ac2 toward the outside in the radial direction by rotating together with the rotation shaft 201; the casing 203 surrounding the rotation shaft 201 and the impeller 202 and in which the diffuser flow path Fb1 guiding the fluid pressure-fed from the impeller 202 toward the outside in the radial direction is formed; and the plurality of diffuser vanes 204 which are provided in the diffuser flow path Fb1 at intervals in the circumferential direction of the axis Ac2, wherein each of the diffuser vanes 204 includes the vane body 41 extending toward the rotation direction of the rotation shaft 201 as the diffuser vane is extended toward the outside in the radial direction and the sound reducer 205 which is formed on the surface 241S of the vane body 241.

According to the above-described configuration, the sound reducer 205 is formed on the surface 241S of the vane body 241. Accordingly, it is possible to absorb and reduce the noise when the fluid flows along the surface 241S of the vane body 241.

(7) In the compressor 200 according to a seventh aspect, the sound reducer 205 is the plurality of recessed portions 205R which are formed on the surface 241S of the vane body 241.

According to the above-described configuration, the sound wave is trapped in the recessed portion 205R as the sound reducer 205 and is attenuated inside the recessed portion 205R. Accordingly, it is possible to reduce the leakage of noise to the outside.

(8) In the compressor 200 according to an eighth aspect, the depth of the recessed portion 205R from the surface 241S is a quarter length of the wavelength of the target sound.

According to the above-described configuration, a non-reflective boundary condition in which Zi is equal to pc is realized at the entrance of the recessed portion 205R by setting the depth of the recessed portion 205R from the surface 241S to a quarter of the wavelength λ of the sound at the frequency to be reduced. Accordingly, the sound wave of the reduction target frequency trapped by the recessed portion 205R can be attenuated inside the recessed portion 205R without being reflected to the outside. (9) In the compressor 200 according to a ninth aspect, the cross-sectional area of the portion on the side of the surface 241S of the recessed portion 205R is larger than that of the other portion.

According to the above-described configuration, the cross-sectional area of the portion on the side of the surface 241S of the recessed portion 205R is larger than that of the other portion. In other words, the cross-sectional area of the entrance of the recessed portion 205R is larger than the cross-sectional area of the bottom portion. Accordingly, it is possible to trap the sound wave in a wider area of the surface 241S of the vane body 241.

(10) In the compressor 200 according to a tenth aspect, the sound reducer 205 is the plurality of passages 205P each of which both ends are opened to the surface 241S of the vane body 241.

According to the above-described configuration, since the sound wave is introduced from one end of the passage 205P, the sound wave is radiated from the other end while the phase of the sound wave is changed in the passage 205P. Since the sound wave radiated from the other end interferes with the sound wave incident on the other end, the sound wave can be attenuated.

(11) In the compressor 200 according to an eleventh aspect, the length of the passage 205P from one end to the other end is twice the wavelength of the target sound.

According to the above-described configuration, the length of the passage 205P is twice the wavelength of the sound to be reduced. Accordingly, the sound (having a positive phase) incident from one end to the passage 205P is emitted as the sound of the negative phase from the other end. Accordingly, it is possible to cancel the sound of the positive phase entering the other end.

(12) The compressor 300 according to a twelfth aspect includes: the rotation shaft 301 which is allowed to rotate around the axis Ac3; the impeller 302 which is configured to pressure-feed a fluid from one side in the direction of the axis Ac3 toward the outside in the radial direction by rotating together with the rotation shaft 301; the casing 303 surrounding the rotation shaft 301 and the impeller 302 and in which the exit flow path Fc guiding the fluid pressure-fed from the impeller 302 is formed; the speaker wall 305 which is provided to face the inside of the exit flow path Fc in the casing 303; the pressure sensor Sp which is configured to detect a pressure inside the exit flow path Fc; and the computing device 90 which is configured to send a signal to the speaker wall 305 to emit a sound having a frequency for canceling a target sound on the basis of the detected value of the pressure sensor Sp.

According to the above-described configuration, the speaker wall 305 emits a sound having a frequency for canceling the sound as the pressure fluctuation detected by the pressure sensor Sp. By this sound, the noise inside the exit flow path Fc can be canceled. Even when the frequency of the noise changes with time, the pressure sensor Sp immediately detects this change and the computing device 90 generates a sound having a frequency for canceling another sound having different frequency. Accordingly, noise can be reduced autonomously regardless of the operating state of the compressor 300.

(13) In the compressor 300 according to a thirteenth aspect, the computing device 90 includes the frequency analysis unit 82 which performs frequency analysis on a detected value of the pressure sensor Sp to be decomposed into a plurality of frequencies, the opposite-phase generation unit 83 which generates a frequency opposite in phase to that of a target sound included in the plurality of frequencies decomposed by the frequency analysis unit 82, and the signal oscillation unit 84 which sends a signal to the speaker wall 305 to emit a sound of the frequency generated by the opposite-phase generation unit 83.

According to the above-described configuration, the frequency analysis unit 82 determines a target sound on the basis of the detected value of the pressure sensor Sp and the opposite-phase generation unit 83 generates a sound having a frequency opposite in phase to that of the target sound. The signal oscillation unit 84 transmits a signal to the speaker wall 305 to emit the opposite-phase sound. Accordingly, noise of a specific frequency can be selectively and effectively reduced.

(14) In the compressor 300 according to a fourteenth aspect, the speaker wall 305 includes the plurality of speaker elements 351b, the opposite-phase generation unit 83 generates a plurality of frequencies opposite in phase to those of a plurality of target sounds, and the signal oscillation unit 84 sends signals to the plurality of speaker elements 351b to emit sounds having opposite-phase frequencies.

According to the above-described configuration, the opposite-phase generation unit 83 generates sounds having frequencies opposite in phase to those of a plurality of target sounds. The signal oscillation unit 84 makes the speaker elements 351b emit the canceling sounds having frequencies opposite in phase to those of target sounds. Thus, noise which occurs in the exit flow path Fc can be reduced in every frequency bands.

### INDUSTRIAL APPLICABILITY

According to the present disclosure, it is possible to provide a compressor having an excellent noise-reduction property.

### REFERENCE SIGNS LIST

100, 200, 300 Compressor
1, 201, 301 Rotation shaft
2, 202, 302 Impeller
3, 203, 303 Casing
4 Return vane
5, 5b, 5c, 5d Acoustic liner
6 Vortex suppressor
7, 7b Plate member
21, 221, 321 Disk
21A, 221A, 321A Main surface
22, 222, 322 Blade
81 Pressure acquisition unit
82 Frequency analysis unit
83 Opposite-phase generation unit
84 Signal oscillation unit
90 Computing device
91 CPU
92 ROM
93 RAM
94 HDD
95 Signal transmission/reception module
204, 304 Diffuser vane
205 Sound reducer
205R Recessed portion
205P Passage
241 Vane body
241S Surface
305, 305b Speaker wall
351, 351b Speaker element
Ac1, Ac2, Ac3 Axis
C Cavity
Fa, Fb, Fc Exit flow path
Fa1, Fb1, Fc1 Diffuser flow path
Fa2, Fb2, Fc2 Exit scroll
h, h2 Introduction hole
in Foam metal
M Junction
Pa, Pb, Pc Compression flow path
S Throat portion
Sp Pressure sensor
t1 One end
t2 Other end
V Acoustic space

1. A compressor comprising:
a rotation shaft which is allowed to rotate around an axis;
an impeller which is configured to pressure-feed a fluid from one side in an axial direction toward an outside in a radial direction by rotating together with the rotation shaft;
a casing surrounding the rotation shaft and the impeller and in which an exit flow path guiding the fluid pressure-fed from the impeller is formed; and
an acoustic liner which is installed to face an inside of the exit flow path in the casing,
wherein the acoustic liner includes:
an acoustic space which is formed inside the acoustic liner;
an introduction hole communicating the acoustic space with the exit flow path; and
a vortex suppressor which is placed in a connection area between the introduction hole and the acoustic space and is configured to suppress vortexes which occur in the connection area.

2. The compressor according to claim 1, wherein the vortex suppressor is formed of a foam metal and covering the introduction hole inside the acoustic space.

3. The compressor according to claim 1, wherein the vortex suppressor includes a plurality of plate members extending from the introduction hole toward the acoustic space and between which a plurality of slits are formed.

4. The compressor according to claim 1,
wherein a cavity having an open area larger than that of the introduction hole is formed at a portion on the side of the acoustic space in the introduction hole, and
wherein the vortex suppressor is placed inside the cavity and includes a plurality of plate members extending from the introduction hole toward the acoustic space and between which a plurality of slits are formed.

5. A compressor comprising:
a rotation shaft which is allowed to rotate around an axis;
an impeller which is configured to pressure-feed a fluid from one side in an axial direction toward an outside in a radial direction by rotating together with the rotation shaft;
a casing surrounding the rotation shaft and the impeller and in which an exit flow path guiding the fluid pressure-fed from the impeller is formed; and
an acoustic liner which is installed to face an inside of the exit flow path in the casing,
wherein the acoustic liner includes:
an acoustic space which is formed inside the acoustic liner; and
a plurality of introduction holes communicating the acoustic space with the exit flow path, and
wherein the plurality of introduction holes are formed to communicate with the acoustic space while coming closer to each other as the introduction holes are extended from the exit flow path toward the acoustic space and perform as a vortex suppressor suppressing vortexes which occur in a connection area between the plurality of introduction holes and the acoustic space.

6. A compressor comprising:
a rotation shaft which is allowed to rotate around an axis;
an impeller which is configured to pressure-feed a fluid from one side in an axial direction toward an outside in a radial direction by rotating together with the rotation shaft;
a casing surrounding the rotation shaft and the impeller and in which a diffuser flow path guiding the fluid pressure-fed from the impeller toward an outside in a radial direction is formed; and
a plurality of diffuser vanes which are provided in the diffuser flow path at intervals in a circumferential direction of the axis,
wherein each of the diffuser vanes includes a vane body extending toward a rotation direction of the rotation shaft as the diffuser vane is extended toward an outside in a radial direction and a sound reducer which is formed on a surface of the vane body.

7. The compressor according to claim 6, wherein the sound reducer is a plurality of recessed portions which are formed on a surface of the vane body.

8. The compressor according to claim 7, wherein a depth of the recessed portion from the surface is a quarter length of a wavelength of a target sound.

9. The compressor according to claim 7, wherein a cross-sectional area of a portion on the surface side of the recessed portion is larger than that of the other portion.

10. The compressor according to claim 6, wherein the sound reducer is a plurality of passages each of which both ends are opened to a surface of the vane body.

11. The compressor according to claim 10, wherein a length of the passage from one end to the other end is twice a wavelength of a target sound.

12. A compressor comprising:
a rotation shaft which is allowed to rotate around an axis;
an impeller which is configured to pressure-feed a fluid from one side in an axial direction toward an outside in a radial direction by rotating together with the rotation shaft;
a casing surrounding the rotation shaft and the impeller and in which an exit flow path guiding the fluid pressure-fed from the impeller is formed;
a speaker wall which is provided to face an inside of the exit flow path in the casing;
a pressure sensor which is configured to detect a pressure inside the exit flow path; and
a computing device which is configured to send a signal to the speaker wall to emit a sound having a frequency for canceling a target sound on the basis of a detection value of the pressure sensor.

13. The compressor according to claim 12, wherein the computing device includes a frequency analysis unit which performs frequency analysis on a detected value of the pressure sensor to be decomposed into a plurality of frequencies, an opposite-phase generation unit which generates a frequency opposite in phase to that of a target sound included in the plurality of frequencies decomposed by the frequency analysis unit, and a signal oscillation unit which sends a signal to the speaker wall to emit a sound of the frequency generated by the opposite-phase generation unit.

14. The compressor according to claim 13,
wherein the speaker wall includes a plurality of speaker elements,
wherein the opposite-phase generation unit generates a plurality of frequencies opposite in phase to those of a plurality of target sounds, and
wherein the signal oscillation unit sends signals to the plurality of speaker elements to emit sounds having opposite-phase frequencies.
